(19) United States
(12) Patent Application Publication
(10) Pub. No.: US 2023/0417449 A1
(43) Pub. Date: Dec. 28, 2023

(54) Air Cooling Mechanism, Air Guide Member and Heating Device

(71) Applicant: Tyco Electronics (Shanghai) Co., Ltd., Shanghai (CN)

(72) Inventor: Zhen Wang, Shanghai (CN)

(73) Assignee: Tyco Electronics (Shanghai) Co., Ltd., Shanghai (CN)

(21) Appl. No.: 18/465,469

(22) Filed: Sep. 12, 2023

Related U.S. Application Data
(63) Continuation of application No. PCT/CN22/79702, filed on Mar. 8, 2022.

(30) Foreign Application Priority Data
Mar. 12, 2021 (CN) 202110270226.3

(51) Int. Cl. F24F 13/08

(52) U.S. Cl. CPC F24F 13/082; B29C 2035/1658

(57) ABSTRACT

An air-cooling mechanism includes an air guiding member and an air blowing member spaced from the air guiding member. An air-cooling area is formed between the air guiding member and the air blowing member. The air-cooling area has an air inlet and an air outlet. The air blowing member blows air towards the air guiding member to form a cooling airflow. The air guiding member includes air blocking plates and air deflecting plates connected to the air blocking plates and extending into the air-cooling area. The air blocking plates block the cooling airflow from flowing out of the air-cooling area, and an air outlet gap is formed between adjacent air blocking plates. The air deflecting plates block the cooling airflow in the air-cooling area from flowing towards the heating area and guide the cooling airflow towards the air outlet gap.

### CROSS-REFERENCE TO RELATED APPLICATIONS

This application is a continuation of PCT International Application No. PCT/CN2022/079702, filed on Mar. 8, 2022, which claims priority under 35 U.S.C. § 119 to Chinese Patent Application No. 202110270226.3, filed on Mar. 12, 2021.

### FIELD OF THE INVENTION

The present invention belongs to the technical field of air-cooling equipment, in particular to an air-cooling mechanism, an air guiding member, and a heating device.

### BACKGROUND

When a heat shrink tube is heated, the parts to be heat shrunk with the heat shrink tube are generally placed on a synchronous belt and transported into a heat shrink machine by the synchronous belt. The heat shrink tube is shrunk on the parts to be heat shrunk under the heat of the heat shrink machine, completing the heat shrink process. The heat shrinkable parts can be cables, etc.

When the completed heat shrinkable cable is moved from the synchronous belt to the collection bin, the temperature of the heat shrink tube on the cable is still very high, and the glue flowing out of the heat shrink tube is still not solidified. When the cables are piled or stacked, there is often adhesion of multiple cables, affecting the quality and appearance of the product. If the heat shrink tube is not properly cooled in a transmission channel, the temperature inside the heat shrinkable machine is reduced, causing incomplete thermal shrinkage of the heat shrink tube and increasing energy consumption of the heat shrink machine.

### SUMMARY

An air-cooling mechanism includes an air guiding member and an air blowing member spaced from the air guiding member. An air-cooling area is formed between the air guiding member and the air blowing member. The air-cooling area has an air inlet and an air outlet. The air blowing member blows air towards the air guiding member to form a cooling airflow. The air guiding member includes air blocking plates and air deflecting plates connected to the air blocking plates and extending into the air-cooling area. The air blocking plates block the cooling airflow from flowing out of the air-cooling area, and an air outlet gap is formed between adjacent air blocking plates. The air deflecting plates block the cooling airflow in the air-cooling area from flowing towards the heating area and guide the cooling airflow towards the air outlet gap.

### BRIEF DESCRIPTION OF THE DRAWINGS

The invention will now be described by way of example with reference to the accompanying Figures, of which:

FIG. 1 is a structural schematic diagram of an air-cooling mechanism according to an embodiment of the present invention;

FIG. 2 is an enlarged view of Part A in FIG. 1;

FIG. 3 is a structural schematic diagram of an air guiding member according to an embodiment of the present invention; and

FIG. 4 is a structural schematic diagram of a heating device according to an embodiment of the present invention.

### DETAILED DESCRIPTION OF THE EMBODIMENTS

The following describes in detail the embodiments of the present invention, examples of which are shown in the accompanying drawings, where the same or similar labels throughout represent the same or similar components or components with the same or similar functions. The embodiments described below with reference to the accompanying drawings are exemplary and are intended to explain the present invention, but should not be understood as limiting the present invention.

In the description of the present invention, it should be understood that the terms “length”, “width”, “top”, “bottom”, “inside”, “outside”, etc. indicate the orientation or position relationship based on the orientation or position relationship shown in the attached drawings, only for the convenience of describing the present invention and simplifying the description, rather than indicating or implying that the device or element referred to must have a specific orientation, or be constructed and operated in a specific orientation. Therefore, it should not be understood as a limitation of the present invention.

In addition, the terms “first” and “second” are only used to describe the purpose and cannot be understood as indicating or implying relative importance or implying the quantity of technical features indicated. Therefore, features limited to “first” and “second” can explicitly or implicitly include one or more of these features. In the description of the present invention, “multiple” means two or more, unless otherwise specifically defined.

In the present invention, unless otherwise specified and limited, the terms “installation”, “connection”, “fixation” and other terms should be broadly understood, for example, they can be fixed connections, detachable connections, or integrated; it can be a mechanical connection or an electrical connection; it can be directly connected or indirectly connected through an intermediate medium, which can be the internal connection between two components or the interaction relationship between two components. For ordinary technical personnel in this field, the specific meanings of the above terms in the present invention can be understood based on specific circumstances.

In order to make the purpose, technical solution, and advantages of the present invention clearer, the following will provide a further detailed explanation of the present invention in conjunction with the accompanying drawings and embodiments. It is evident that the accompanying drawings described below are only some embodiments of the present invention.

The present invention provides an air-cooling mechanism 100 for cooling a component to be cooled, which can be a cable sheathed with a heat shrink tube.

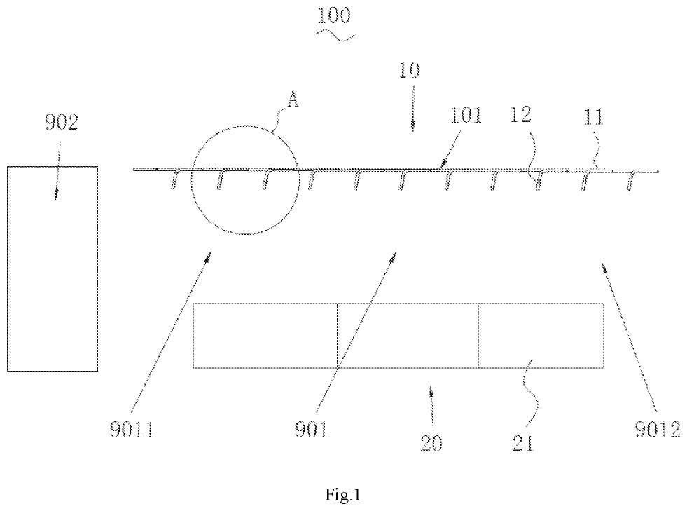

As shown in FIG. 1, the air-cooling mechanism 100 includes an air guiding member 10 and an air blowing member 20. The air guiding member 10 and the air blowing member 20 are spaced. An air-cooling area 901 is formed between the air guiding member 10 and the air blowing member 20. The air-cooling area 901 is provided with an air inlet 9011 and an air outlet 9012 along the first predetermined direction for the component to be cooled to pass through. The air inlet 9011 is located near a heating area 902. That is to say, after the element to be cooled is sent out from the heating area 902, it can enter the air-cooling area 901 from the air inlet 9011, and then be sent out from the air outlet 9012.

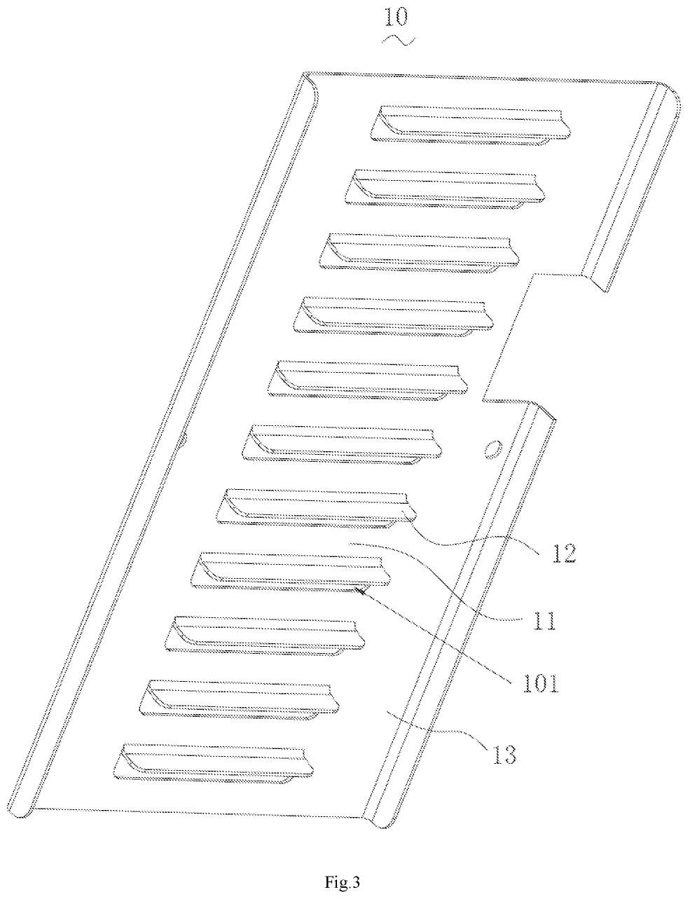

As shown in FIGS. 1 and 3, the air guiding member 10 includes multiple air blocking plates 11 and multiple air deflecting plates 12. The multiple air blocking plates 11 are spaced along the second predetermined direction. An air outlet gap 101 is formed between adjacent air blocking plates 11. Each air deflecting plate 12 is connected to one air blocking plate 11 and extends into the air-cooling area 901. That is to say, multiple air deflecting plates 12 are spaced along the second predetermined direction, and the extension direction of the air deflecting plate 12 is towards the air-cooling area 901. Among them, the second predetermined direction can be any direction, with the length direction of the air outlet gap 101 and the air blocking plate 11 perpendicular to the second predetermined direction, and the width direction in the same direction as the second predetermined direction.

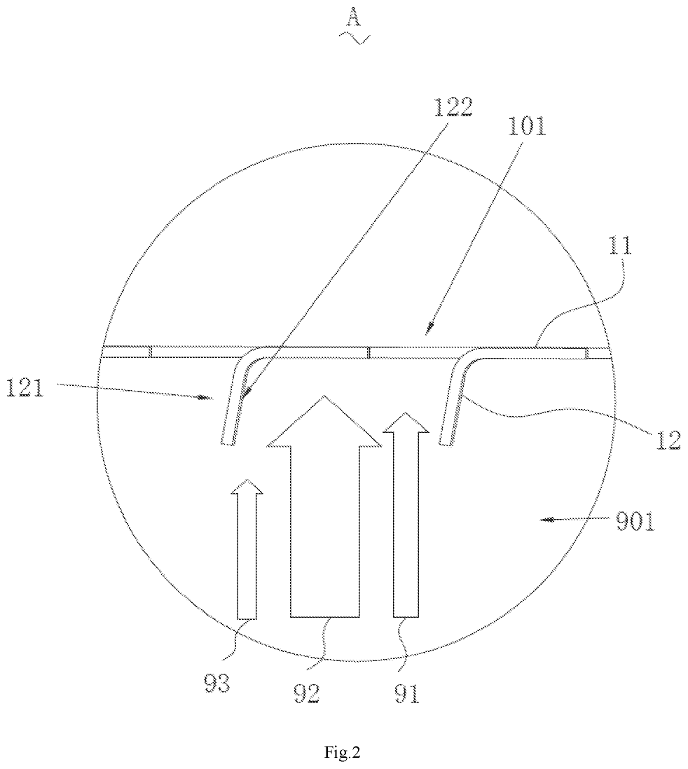

The air blowing member 20, shown in FIGS. 1 and 2, is set to blow towards the air guiding member 10 to form a cooling airflow. The cooling airflow flows from the air blowing member 20 towards the air guiding member 10, and the air blocking plate 11 is set to block the cooling airflow from flowing out of the air-cooling area 901. The air blowing member 20, in an embodiment, includes multiple fans 21, which are arranged along the first predetermined direction, that is, multiple fans 21 are arranged along the direction from the air inlet 9011 to the air outlet 9012 of the air-cooling area 901. Among them, one fan 21 corresponds to several air outlet gaps 101 to improve heat dissipation efficiency. In other embodiments, the air blowing member 20 can also be a blowing machine.

The air deflecting plate 12 can block the cooling airflow in the air-cooling area 901 from flowing towards the heating area 902, and guide the cooling airflow in the air-cooling area 901 towards the air outlet gap 101, so that the cooling airflow flows out from the air outlet gap 101. Due to the guiding effect of the air deflecting plate 12, the cooling airflow cannot diffuse in the second predetermined direction, thereby reducing the loss and diffusion of heat in the air-cooling area 901.

In an embodiment, the first predetermined direction is in the same direction as the second predetermined direction. At this time, the air deflecting plate 12 can prevent the cooling airflow in the air-cooling area 901 from flowing towards the heating area 902 along the first predetermined direction, thereby reducing the impact of the cooling airflow in the air-cooling area 901 on the heating area 902.

Specifically, the air deflecting plate 12 can guide the cooling airflow in the air-cooling area 901 towards the air blocking plate 11, so that the cooling airflow is blocked by the air blocking plate 11, and the cooling airflow ultimately flows out through the air outlet gap 101 through the action of air pressure. The air deflecting plate 12 can also guide the cooling airflow in the air-cooling area 901 towards the air outlet gap 101, so that the cooling airflow flows out from the air outlet gap 101. The air deflecting plate 12 can also guide the cooling airflow blocked by the air blocking plate 11 towards the air outlet gap 101, so that the cooling airflow flows out from the air outlet gap 101. The first air flow 91 can directly flow out from the air outlet gap 101. The air deflecting plate 12 has a first side 121 and a second side 122, shown in FIG. 2. The air deflecting plate 12 is connected to the edge of the air blocking plate 11, and the first side 121 of the air deflecting plate 12 is closer to the air outlet gap 101 compared to the second side 122 as an example.

As shown in FIG. 2, there is an angle between the air deflecting plate 12 and the air blocking plate 11. When the angle between the two is equal to 90 degrees, the cooling airflow can be divided into the first air flow 91 that directly blows towards the air outlet gap 101 and a second air flow 92 that directly blows towards the air blocking plate 11. The first air flow 91 can directly flow out from the air outlet gap 101. The second air flow 92 is blocked by the second side 122 of the air blocking plate 12 and accumulates on the side of the air blocking plate 12 towards the air-cooling area 901. As the second air flow 92 continues to accumulate, the air pressure in the area near the air blocking plate 11 in the air-cooling area 901 increases until the second air flow 92 flows to the first side 121 of the adjacent air deflecting plate 12 under the action of the air pressure. Due to the guiding effect of the first side 121 of the other air deflecting plate 12, a third air flow 93 and the second air flow 92 flow out of the air outlet gap 101 along the extension direction of the air deflecting plate 12.

When the angle between the two is not equal to 90 degrees, the cooling airflow can be divided into a first air flow 91 that directly blows towards the air outlet gap 101, the second air flow 92 that directly blows towards the air blocking plate 11, and the third air flow 93 that directly blows towards the air deflecting plate 12. The first air flow 91 can directly flow out from the air outlet gap 101. The second air flow 92 is blocked by the air blocking plate 11 and accumulates on the side of the air blocking plate 12 towards the air-cooling area 901. The third air flow 93 flows to the air outlet gap 101 or air blocking plate 11 under the guidance of the air deflecting plate 12.

In an example, the first side 121 of the air deflecting plate 12 faces roughly downwards, and the second side 122 is roughly facing upwards. The first side 121 of the air deflecting plate 12 guides the third air flow 93 directly to the air outlet gap 101, and the third air flow 93 flows out from the air outlet gap 101.

In an example, the first side 121 of the air deflecting plate 12 faces roughly upwards, and the second side 122 faces roughly downwards, as shown in FIG. 2. The second side 122 of the air deflecting plate 12 guides the third air flow 93 directly to the air blocking plate 11. The third air flow 93 merges with the second air flow 92. Due to the blocking effect of the air blocking plate 11, the third air flow 93 and the second air flow 92 accumulate on the side of the air blocking plate 11 towards the air-cooling area 901, resulting in a higher air pressure in the area near the air blocking plate 11 until the third air flow 93 and second air flow 92 flow to the first side 121 of the adjacent air deflecting plate 12 under the action of air pressure. Due to the guidance of the first side 121 of the adjacent air deflecting plate 12, the third air flow 93 and second air flow 92 flow out of the air outlet gap 101 along the extension direction of the air deflecting plate 12. At the same time, the first air flow 91 is also affected by the second air flow 92 and third air flow 93 and roughly flows out of the air outlet gap 101 along the extension direction of the air deflecting plate 12. In this way, the obstruction of air blocking plate 11 has a buffering effect on the flow of cooling airflow generated by air blowing member 20, slowing down the speed of cooling airflow flowing out of air-cooling area 901, thereby reducing heat loss in air-cooling area 901 and providing insulation for the heat inside the air-cooling area 901. At the same time, the drainage effect of flow deflector 12 can limit the diffusion of heat, which not only has a certain insulation effect, it also avoids the influence of cooling airflow on the heating area 902. The air-cooling mechanism 100 can cool and solidify the materials in the air-cooling area 901 through the flow of air-cooling air, with little impact on the air-cooling area 901.

Multiple air deflecting plates 12 are roughly parallel to each other, so that the wind direction of the cooling airflow flowing out of the air outlet gap 101 is roughly the same. The term “roughly parallel” refers to multiple air deflecting plates 12 being parallel or with an angle difference of no more than 5 degrees between them.

In the embodiment shown in FIG. 1, the air blocking plate 11 is parallel to the second predetermined direction, so that multiple air blocking plates 11 are on the same plane, and the air outlet gap 101 is also on the same plane as the air blocking plate 11. This further restricts the third and second air flows 93 and 92 that accumulate inside the air blocking plate 11 from flowing out from the air outlet gap 101 along the air blocking plate 11, and can only flow out through the drainage effect of the air deflecting plate 12. The air deflecting plate 12 further weakens the flow rate of the cooling airflow during drainage. The flow direction of the cooling airflow generated by the air blowing member 20 can be selected to be perpendicular to the plane where the air blocking plate 11 is located. At this time, the air blocking plate 11 only has a blocking effect on the cooling airflow, further limiting the flow of the third and second air flows 93 and 92 along the air blocking plate 11.

In an embodiment, the width of the air blocking plate 11 in the second predetermined direction can be greater than the width of the air outlet gap 101 in the second predetermined direction, in order to reduce the proportion of ventilation openings formed by multiple air outlet gaps 101, so that the multiple air blocking plates 11 have better insulation effect and reduce heat loss in the air-cooling area 901.

In an embodiment, the extension length of the air deflecting plate 12 is greater than or equal to the width of the air outlet gap 101 in the predetermined direction. At this time, the extension length of the air deflecting plate 12 towards the air-cooling area 901 is longer, which can guide more cooling airflow towards the air blocking plate 11 to better limit the diffusion of cooling airflow within the air-cooling area 901 towards the surrounding area.

In an embodiment, the extension length of the air deflecting plate 12 is smaller than the width of the air blocking plate 11 in the second predetermined direction. At this point, the width of air blocking plate 11 is larger for better insulation effect.

In order to guide the cooling airflow out of the air outlet gap 101, the air deflecting plate 12 is connected to the edge of the air blocking plate 11, as shown in FIG. 1. At this time, one side of the air deflecting plate 12 is the air outlet gap 101, and the other side is the air blocking plate 11. The side facing the air blocking plate 11 can guide the cooling airflow to gather at the air blocking plate 11. The side facing the air outlet gap 101 can guide the cooling airflow directly out of the air outlet gap 101, improving the heat dissipation effect and facilitating processing.

In the embodiment shown in FIG. 1, the air deflecting plate 12 and the air blocking plate 11 are arranged at an obtuse angle. In this way, the third air flow 93 that directly flows to the air deflecting plate 12 flows to the air blocking plate 11 under the guidance of the air deflecting plate 12. At the same time, the air deflecting plate 12 can block some of the air outlet gap 101 in the blowing direction of the air blowing member 20, thereby reducing the flow of the first air flow 91, further reducing the flow of cooling air from the air outlet gap 101, and improving the insulation effect. In other embodiments, the air deflecting plate 12 and the air blocking plate 11 can also be arranged at acute or right angles.

However, if the third and second air flows 93 and 92 accumulate too much and cannot flow out in a timely manner, it is easy to generate internal circulation of cooling airflow in the air-cooling area 901, affecting the heat of the heating area 902. Therefore, the projection of the air outlet gap 101 on the air blowing member 20 covers the projection of the air deflecting plate 12 on the air blowing member 20, which means that the air deflecting plate 12 does not completely block the air outlet gap 101 in the blowing direction of the air blowing member 20. This allows some of the cooling airflow to directly flow out through the air outlet gap 101, ensuring good heat dissipation and air-cooling effects.

If the angle between the air deflecting plate 12 and the air blocking plate 11 is too large, it will not only block too much cooling airflow from directly flowing out of the air outlet gap 101, affecting the air-cooling effect, but also reduce the guiding effect of the air deflecting plate 12 on the cooling airflow. Therefore, the angle between the air deflecting plate 12 and the air blocking plate 11 can be set to be greater than or equal to 90 degrees and less than or equal to 135 degrees.

In the embodiment shown in FIG. 1, the angle between the air deflecting plate 12 and the air blocking plate 11 is equal to 100 degrees. At this angle, the air deflecting plate 12 can better guide the cooling airflow accumulated in the air blocking plate 11 to flow out of the air outlet gap 101 while not blocking too much air outlet gap 101, and limit the diffusion of the cooling airflow.

The air deflecting plate 12 is connected to the side of the corresponding air blocking plate 11 near the heating area 902. Through the guidance of the air deflecting plate 12, the cooling airflow flowing out of the air outlet gap 101 is tilted towards the side away from the heating area 902 and discharged to prevent the cooling airflow from blowing back into the heating area 902, and to prevent hot air from exiting onto operators working near the heating area 902.

In the embodiment shown in FIGS. 1 and 3, for ease of processing, the air blocking plate 11 and the air deflecting plate 12 are integral parts. The air guiding member 10 can be formed by machining a flat plate, specifically by cutting the contour of the air deflecting plate 12 on the flat plate, and then bending the air deflecting plate 12 towards one side through stamping or other methods. In this embodiment, the air deflecting plate 12 is bent 80 degrees, and the gap that appears on the flat plate is the air outlet gap 101, and the air blocking plate 11 is formed between the adjacent two air outlet gaps 101. The air guiding member 10 made by this processing method has low cost, stable structure, and more precise size compared to the air guiding member 10 assembled by welding and other methods, which is not easy to break.

In this embodiment, the connection between the air deflecting plate 12 and the air blocking plate 11 is rounded to generate a force for the third air flow 93 guided by the air deflecting plate 12 to flow towards another adjacent air deflecting plate 12 when the air blocking plate 11 is in the flow channel, while driving the second air flow 92 to flow towards the adjacent another air deflecting plate 12 until the third air flow 93 and second air flow 92 flow to the adjacent another air deflecting plate 12, and then flow out from the air outlet gap 101 through another adjacent air deflecting plate 12.

In an embodiment, the projection of the air outlet gap 101 on the air blowing member 20 has a length along a direction perpendicular to the second predetermined direction which is greater than the length of the fan 21 along the direction perpendicular to the second predetermined direction, so that the cooling airflow formed by the fan 21 can be covered by the air guiding member 10 in the length direction, preventing the diffusion of the cooling airflow. It should be noted that the length direction of air outlet gap 101 is perpendicular to the second predetermined direction, and the length of fan 21 is the length in the length direction of air outlet gap 101. In the second predetermined direction, one fan corresponds to several air outlet gaps 101.

In the embodiment shown in FIG. 1, at least one air deflecting plate 12 is closer to the air inlet 9011 in the second predetermined direction compared to the air blowing member 20. The air deflecting plate 12 closer to the air inlet 9011 can restrict the cooling airflow from flowing out of the air inlet 9011. At least one air deflecting plate 12 is closer to the air outlet 9012 in the second predetermined direction than the air blowing member 20, and the air deflecting plate 12 that is closer to the air outlet 9012 of the air-cooling area can restrict the cooling airflow from flowing out of the air outlet 9012. In this way, the cooling airflow blown out by the air blowing member 20 is within the coverage range of the air guiding member 10, which means that the cooling airflow can be guided by the air deflecting plate 12 at both ends of the air guiding member 10. The air deflecting plates 12 at both ends of the air guiding member can limit the diffusion of the cooling airflow towards the surrounding area.

The present invention also provides an air guiding member 10 for guiding the cooling airflow from the air inlet 9011 to the air outlet 9012. Among them, the air inlet 9011 can be equipped with an air blowing member 20 to generate a cooling airflow flowing towards the air outlet 9012.

The air guiding member 10, as shown in FIG. 3, includes a bracket body 13, multiple air blocking plates 11, and multiple air deflecting plates 12. Multiple air blocking plates 11 are respectively connected to the bracket body 13 and are configured to block the passage of cooling airflow. The multiple air blocking plates 11 are spaced along the first predetermined direction. An air outlet gap 101 is formed between two adjacent air blocking plates 11. The air deflecting plate 12 is connected to the air blocking plate 11 and extends towards the air inlet. The air blocking plate 11 and air deflecting plate 12 have the same structure and function as the air blocking plate 11 and air deflecting plate 12 in the above embodiments, and will not be repeated here. The bracket body 13 is used to support the air blocking plate 11, so that multiple air blocking plates 11 are arranged in intervals along the first predetermined direction. In this embodiment, multiple air blocking plates 11 are coplanar with the bracket body 13 to facilitate processing. The bracket body 13 can be connected to the edge of the air outlet 9012, and the air deflecting plate 12 extends to the air outlet 9012 to guide the airflow blown from the air inlet 9011 into the air outlet 9012. The air guiding member 10 is an integral component, which is formed by stamping a flat plate. The air guiding member 10 made through this processing method is easy to process and has low cost.

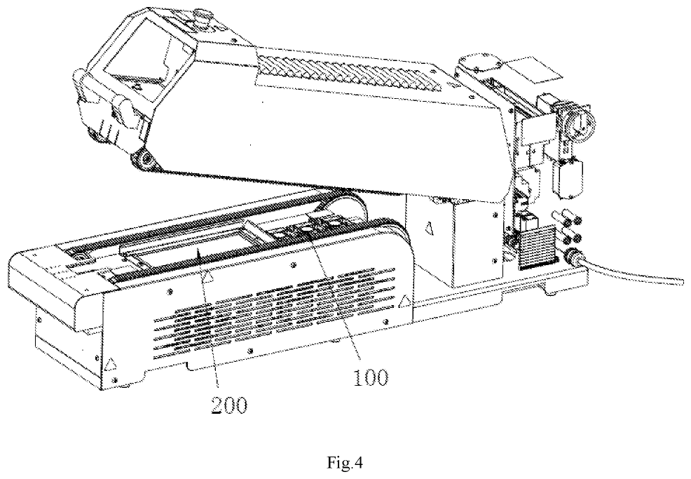

The present invention also provides a heating device, as shown in FIGS. 1 and 4. The heating device includes a heating mechanism 200 and an air-cooling mechanism 100 as described in the above embodiments. The air-cooling mechanism 100 has the same structure and function as the air-cooling mechanism 100 in the above embodiments, and will not be repeated here. The heating mechanism 200 is equipped with a heating area 902, and the heat in the heating area 902 can heat the materials in the heating area 902. The air-cooling area 901 is set near the heating area 902, allowing the material to enter the air-cooling area 901 for cooling after heating treatment.

In use, the material is first placed in the heating area 902 for heating. After the heating process is completed, the material becomes a component to be cooled, and then the component to be cooled is transported to the air-cooling area 901 of the air-cooling mechanism 100 for heat dissipation, allowing the material to be cooled and solidified through a cooling airflow. The air guiding member 10 can guide the cooling airflow blown out by the air blowing member 20 to flow away from the heating mechanism 200 and discharge it from the air-cooling area 901. In an embodiment, the air deflecting plate 12 is located near the edge of the heating area 902 of the air blocking plate 11 and is arranged at an obtuse angle with the air blocking plate 11. This way, when the air-cooling mechanism 100 cools and solidifies the material, the cooling airflow in the air-cooling area 901 will not flow towards the heating area 902 due to the obstruction of the air deflecting plate 12. At the same time, the air blocking plate 11 provides insulation for the air-cooling area 901 connected to the heating area 902 to avoid affecting the heat in the heating area 902. Moreover, the cooling airflow discharged from the air-cooling area 901 flows far away from the heating mechanism 200 to avoid the influence of the discharged cooling airflow on operators working near the heating mechanism 200.

In this embodiment, the material can be a cable with a heat shrink tube, and the heating mechanism 200 is a heat shrink machine. When the material is placed in the heating area 902 of the heating mechanism 200, the heat shrink tube undergoes heat shrinkage, and the colloid inside the heat shrink tube melts. After the material is transported to the air-cooling area 901 of the air-cooling mechanism 100, the colloid can be solidified by the cooling airflow generated by the air blowing member 20. Due to the temperature retention effect of the air blocking plate 11 and the anti-diffusion effect of the air deflecting plate 12, the cooling airflow will not affect the heat shrink process of the heat shrink tube in the heating area 902. Thus, it does not increase the energy consumption of the heat shrinking machine.

The above is only an embodiment of the present invention, and only one specific description of the technical principles of the present invention is provided. These descriptions are only for the purpose of explaining the principles of the present invention and should not be interpreted in any way as limiting the scope of protection of the present invention. Based on this explanation, any modifications, equivalent substitutions, and improvements made within the spirit and principles of the present invention, as well as other embodiments of the present invention that can be associated by technical personnel in the art without the need for creative labor, shall be included in the scope of protection of the present invention.

What is claimed is:

1. An air-cooling mechanism, comprising:
an air guiding member; and
an air blowing member spaced from the air guiding member, an air-cooling area is formed between the air guiding member and the air blowing member, the air-cooling area has an air inlet and an air outlet along a first predetermined direction for materials to pass through, the air inlet of the air-cooling area is arranged near a heating area, the air blowing member blows air towards the air guiding member to form a cooling airflow, the air guiding member includes a plurality of air blocking plates and a plurality of air deflecting plates connected to the air blocking plates and extending into the air-cooling area, the air blocking plates are spaced along a second predetermined direction and block the cooling airflow from flowing out of the air-cooling area, and an air outlet gap is formed between adjacent air blocking plates of the plurality of air blocking plates, the air deflecting plates block the cooling airflow in the air-cooling area from flowing towards the heating area and guide the cooling airflow in the air-cooling area towards the air outlet gap, so that the cooling airflow flows out through the air outlet gap.

2. The air-cooling mechanism according to claim 1, wherein the air blocking plates are parallel to the second predetermined direction.

3. The air-cooling mechanism according to claim 1, wherein the air deflecting plates are roughly parallel to each other.

4. The air-cooling mechanism according to claim 1, wherein an extension length of one of the air deflecting plates is greater than or equal to a width of the air outlet gap in the second predetermined direction.

5. The air-cooling mechanism according to claim 1, wherein an extension length of one of the air deflecting plates is less than a width of one of the air blocking plates in the second predetermined direction.

6. The air-cooling mechanism according to claim 1, wherein one of the air deflecting plates is connected an edge of one of the air blocking plates.

7. The air-cooling mechanism according to claim 6, wherein a projection of the air outlet gap on the air blowing member covers a projection of the air deflecting plates on the air blowing member.

8. The air-cooling mechanism according to claim 6, wherein the one of the air deflecting plates and the one of the air blocking plates are arranged at an obtuse angle.

9. The air-cooling mechanism according to claim 6, wherein the obtuse angle is greater than or equal to 90 degrees and less than or equal to 135 degrees.

10. The air-cooling mechanism according to claim 9, wherein the obtuse angle is equal to 100 degrees.

11. The air-cooling mechanism according to claim 1, wherein one of the air deflecting plates is connected to a side of a corresponding one of the air blocking plates near the heating area.

12. The air-cooling mechanism according to claim 1, wherein the first predetermined direction is a same direction as the second predetermined direction, and at least one of the air deflecting plates is closer to the air inlet of the air-cooling area in the second predetermined direction than the air blowing member.

13. The air-cooling mechanism according to claim 12, wherein at least one of the air deflecting plates is closer to the air outlet of the air-cooling area in the second predetermined direction than the air blowing member.

14. The air-cooling mechanism according to claim 1, wherein a width of one of the air blocking plates in the second predetermined direction is greater than a width of the air outlet gap in the second predetermined direction.

15. The air-cooling mechanism according to claim 1, wherein the air blocking plates and the air deflecting plates are formed into an integral piece.

16. The air-cooling mechanism according to claim 1, wherein the air blowing member has a plurality of fans, and a projection of the air outlet gap on the air blowing member has a length in a direction perpendicular to the second predetermined direction that is greater than a length of one of the fans in the direction perpendicular to the second predetermined direction, one of the fans corresponds to a plurality of air outlet gaps in the second predetermined direction.

17. An air guiding member for guiding cooling airflow from an air inlet to an air outlet, comprising:
a bracket body;
a plurality of air blocking plates connected to the bracket body and spaced along a first predetermined direction; and
a plurality of air deflecting plates respectively connected to the air blocking plates and extending towards the air inlet, the air blocking plates block a passage of cooling airflow, and an air outlet gap is formed between a pair of adjacent air blocking plates of the plurality of air blocking plates.

18. The air guiding member according to claim 17, wherein the air blocking plates are coplanar with the bracket body.

19. The air guiding member according to claim 17, wherein the air guiding member is an integral piece.

20. A heating device, comprising:
a heating mechanism having a heating area for heating a plurality of materials in the heating area; and
an air-cooling mechanism including an air guiding member and an air blowing member spaced from the air guiding member, an air-cooling area is formed between the air guiding member and the air blowing member, the air-cooling area has an air inlet and an air outlet along a first predetermined direction for the materials to pass through, the air inlet of the air-cooling area is arranged near the heating area, the air blowing member blows air towards the air guiding member to form a cooling airflow, the air guiding member includes a plurality of air blocking plates and a plurality of air deflecting plates connected to the air blocking plates and extending into the air-cooling area, the air blocking plates are spaced along a second predetermined direction and block the cooling airflow from flowing out of the air-cooling area, and an air outlet gap is formed between adjacent air blocking plates of the plurality of air blocking plates, the air deflecting plates block the cooling airflow in the air-cooling area from flowing towards the heating mechanism and the heating area and guide the cooling airflow in the air-cooling area towards the air outlet gap, so that the cooling airflow flows out through the air outlet gap, the materials enter into the air-cooling area for cooling after heating treatment.
